(19) United States
(12) Patent Application Publication
(10) Pub. No.: US 2017/0101531 A1
(43) Pub. Date: Apr. 13, 2017

(54) Devices and methods concerning detectable components

(71) Applicant: ABB Schweiz AG, Baden (CH)

(72) Inventors: MARTIN SCOTT GALEHOUSE, Simpsonville, SC (US); William Greg Hewitt, Taylors, SC (US); Vasilios B. Kapousidis, Greenville, SC (US)

(21) Appl. No.: 15/237,294

(22) Filed: Aug. 15, 2016

Related U.S. Application Data
(60) Provisional application No. 62/205,679, filed on Aug. 15, 2015.

(51) Int. Cl. C08L 77/06

(52) U.S. Cl. CPC C08L 77/06; F16H 57/032

(57) ABSTRACT

A composition for a shaft end closure that includes a first component that can be a plastic material and at least one, or both, of a second component and a third component, the second and third components being different than the first material. The second and third components can enhance the detection of the composition and/or of the shaft end closure by different types of electronic detection devices. The second component can comprise a ferrous and/or non-ferrous metal material, including, for example, a plurality of metal flakes that are detectable by metal detection devices. The third component can be a compound, including, for example, barium, that is detectable by X-ray devices. The second and third components can comprise from about 1% to about 20% by weight of the composition.

### CROSS REFERENCE TO RELATED APPLICATIONS

The present application claims the benefit of U.S. Provisional Patent Application Ser. No. 62/205,679, filed Aug. 15, 2015, which is incorporated herein by reference in its entirety.

### FIELD OF INVENTION

Embodiments of the present application generally relate to shaft end enclosures or covers. More particularly, but not exclusively, embodiments of the present application relate to systems and methods concerning detection of polymer enclosures or portions thereof during manufacturing processes.

### BACKGROUND

In at least certain types of applications, equipment and/or components utilized in the transmission of power may be primarily constructed from non-metallic based materials. For example, in an effort to eliminate at least certain types of bacteria, equipment or associated components used in the manufacturing and/or processing of food and beverage products may be regularly subjected to relatively extreme wash down in which the equipment and components are power washed with water and/or chemical agents. Yet, such wash downs can accelerate the deterioration of at least certain metal based equipment and components. Thus, in at least some industries, certain types of equipment or components may be constructed from a non-metallic material, such as, for example, a polymer. For example, certain types of power transmission components, including, but not limited to, support or bearing housings, shaft end closures, gear boxes, and/or motor housings or enclosures may be constructed from a polymer.

While use of polymers for at least certain types of power transmission components can be beneficial in terms of corrosion or rust resistance, polymers can be relatively undetectable by certain types of detection devices. For example, during a manufacturing or processing operation, a power transmission component, or a fragment thereof, may become dislodged from its associated device, machine, or equipment. When such dislodging or breakage of the component occurs, there is the possibility that the component, or a portion thereof, may become placed in the product that is being manufactured or processed. For example, during food manufacturing processing, a shaft end closure can become dislodged for a support housing and enter into a food or beverage product. While certain regulations and/or guidelines require inspection of food or beverage products for the presence of such potential contaminants, the nature of polymer materials make such detection of dislodged or broken polymer components in food and beverage products difficult. For example, the nature or properties of polymers can make detection of polymers by X-ray and metal detection equipment problematic. Thus, in at least certain situations, contamination associated with a dislodged or broken portion of a polymer component being present in a manufactured or processed product may not be identified until the later stages of the manufacturing process. Moreover, in such situations, the detection, if any, of the dislodged or broken polymer component may not occur until there is a visual inspection and recognition of the detect, such as, for example, by visual recognition of colored fragments of the polymer component. In at least some of these cases, there may be no way to tell how much of the product is effected during processing, and which can result in the entire manufactured lot needing to be discarded.

### BRIEF SUMMARY

An aspect of an embodiment of the present application is a shaft end closure having a body portion structured for mounting to a power transmission component, the body portion formed from a composition comprising a first component, a second component, and a third component. According to certain embodiments, the first component can comprise a polymer while the second component can comprise a material that enhances detection of the composition by a first electronic detection device. Further, the third component can comprise a compound that enhances detection of the composition by a second electronic detection device that detects different characteristics of the composition than the first electronic detection device, the second and third components being different that the first component.

Another aspect of an embodiment of the present application is a shaft end closure formed from a composition consisting of a first component comprising at least one of a polypropylene, a polycarbonate, a polyterephthalate (PET) and a polyamide. The composition can further include a second component comprising a plurality of metal particles in a plastic carrier, the metal particles having an average particle size of at least 10 microns. Additionally, the composition can include a third component comprising barium sulfate. Further, composition of the shaft end closure is detectable by X-ray and metal detection devices.

### BRIEF DESCRIPTION OF THE DRAWINGS

The description herein makes reference to the accompanying figures wherein like reference numerals refer to like parts throughout the several views.

FIG. 1A illustrates a front side perspective view of a mounted ball bearing device having an exemplary shaft cover and a coupled to a shaft according to an illustrated embodiment of the present application.

FIG. 1B illustrates a front side perspective view of an exemplary shaft cover according to an illustrated embodiment of the present application.

FIG. 2A illustrates a side view of an exemplary shaft cover constructed from a material that includes a first, second, and third component.

FIG. 2B illustrates a side view of an exemplary shaft cover having a first portion that is constructed from a material that includes a first and a second component and a second portion that is constructed from a material that includes a first and a third component.

FIG. 3 illustrates a front side perspective view of an exemplary shaft cover according to an illustrated embodiment of the present application.

FIG. 4 illustrates a front side perspective view of an exemplary shaft cover according to an illustrated embodiment of the present application.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DETAILED DESCRIPTION

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

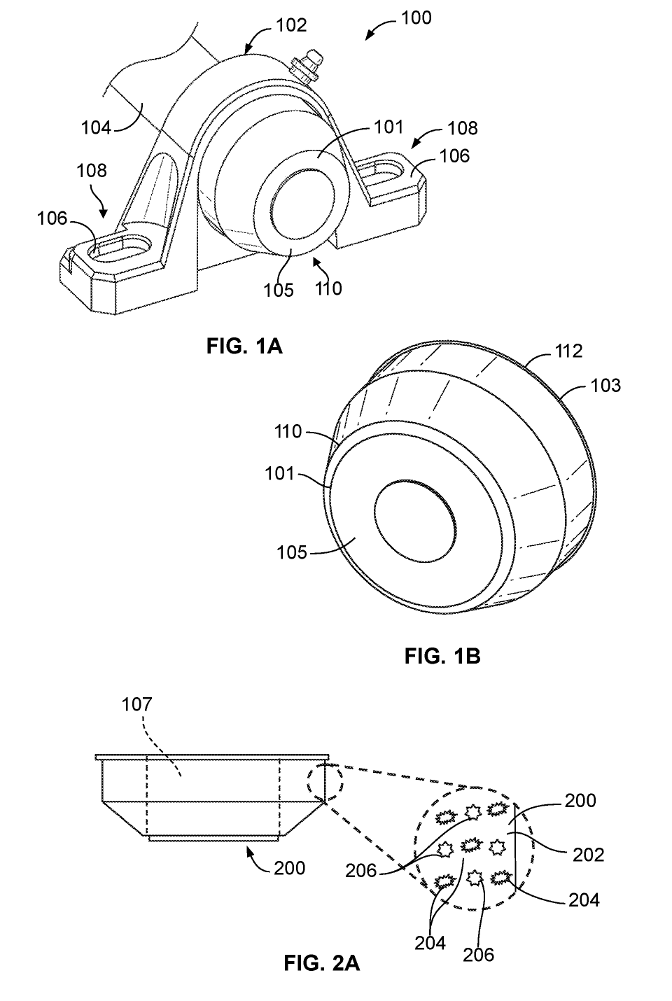

FIG. 1 illustrates a front side perspective view of a mounted ball bearing device 100 having an exemplary shaft cover 110 and a coupled to a shaft 104 according to an illustrated embodiment of the present application. The illustrated mounted ball bearing device 100 can include a body portion, such as a housing 102, having an internal rotating mechanism that receives the shaft 104. For example, according to the illustrated embodiment, the internal rotating mechanism can, for example, include a cage in which a plurality of individual bearings (not shown) are mounted in a common arrangement. The illustrated housing 102 includes two mounting tabs 106 on opposing sides of the ball bearing device 100. Each tab 106 can be adapted to facilitate the mounting of the ball bearing device 100. For example, the tabs 106 can each having an opening 108 extending there-through that is sized to receive insertion of a mechanical fastener, such as, for example, a bolt, screw, or pin, among other fasteners, can be used to secure or mount the device 100 to another device, structure, and/or surface.

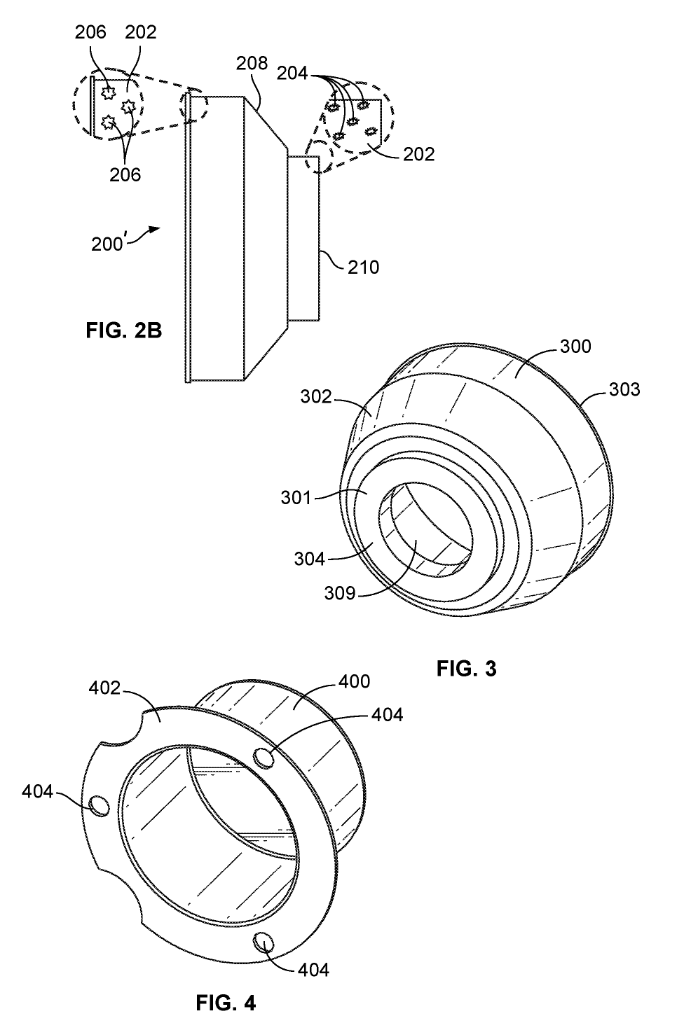

The shaft cover 110 can extend from a first end 101 to a second end 103. Further, at least one of the ends 101, 103 may include an end wall 105 that can prevent ingress/egress through at least the end cover 110. Further, according to certain embodiments, an inner region 107 (FIG. 2A) of the end cover 110 that is sized to at least receive at least a portion of the shaft 104 may extend through at least one of the ends 101, 103. Thus, according to certain embodiments, the at least one of the first and second ends 101, 103 of the cover 110 can include an opening so as to accommodate passage of at least a portion of a component, such as the shaft 104, through that end(s) 101, 103.

The shaft cover 110 can be structured to be coupled or otherwise secured or fastened to the housing 102 in a variety of different manners. For example, according to certain embodiments, the cover 110 may be fastenable to the housing 102 via a snap-fit connection. Such a snap-fit connection can, according to certain embodiments, may be provided by a protrusion or other portion of the cover 110 and/or housing 102 being bent, deformed, or deflected, or otherwise flexible, in a manner that can accommodate assembly, and eventual relative selectively removable or, alternatively, permanent engagement to the other of the cover 110 and/or housing 102. For example, according to the embodiment depicted in FIG. 1B, an end of the cover 110 can include, or be proximally adjacent to, a radially extending flange 112 that interfaces with a complementary groove in the housing 102 in a manner that can at least assist in fastening the cover 110 to the housing 102.

While the cover 110 shown in FIGS. 1A and 1B has a generally cylindrical shape with at least one closed end 101, the cover 110 of the present teachings can take a variety of other forms. For example, as shown in FIG. 3, according to certain embodiments, the cover 300 can be an open-ended cover 300 in which opposing ends 301, 303 of the cover 300 include an opening 309. Further, the cover 300 can include a fixed member 302 at least at one end 301 of and a rotating member 304 that is constructed, at least in part, to rotate relative to the fixed member 302. While the cover 300 can have a variety of different configurations, in the embodiment depicted in FIG. 3 the cover 300 can be snapped fitted to a housing 102 in a manner similar to that as previously discussed with respect to the cover 110 depicted in FIGS. 1A and 1B. FIG. 4 illustrates a front side perspective view of another exemplary shaft cover 400 according to an illustrated embodiment of the present application. The cover 400 shown in FIG. 4 can be structured to be secured to a bearing housing or gearbox housing via mechanical fasteners, such as, for example, via screws, bolts, pins, among other fasteners, that can be inserted through openings 402 in a flange 404 of the cover 400. Unlike the cover 300 depicted in FIG. 3, the cover 400 shown in FIG. 4 may be formed as a single, unitary or monolithic piece of material or component that contains no moving parts or components. While several forms of covers 110, 200, 200′, 300, 400 are described herein, the present teachings are in no way limited to these covers, and can be applied to any form of shaft cover, including those having differing form factors, securing features, and those capable of being secured to other structures in addition to those described herein.

The cover 200, 200′ can be constructed from a variety of materials. For example, referencing FIG. 2A, according to one aspect of the present a cover 200 can be constructed using a material that includes at least a first component 202 and a second component 204, the first component 202 being different than the second component 204. Further, the second component 204 can be detectable by certain examination equipment that generally does not, or cannot, detect the first component 202 and/or which is structured to detect the second component 204. Additionally, according to certain embodiments, in addition to a first and second components 202, 204, the cover 200 can also be constructed from a third component 206 that is different than the first and second components 202, 204, and which may be detectable by equipment by at least equipment that can detect the third component, and which may or may not generally detect the first and/or second components 202, 204. Similarly, according to certain embodiments, the second component 206 can be a material that is be detectable by certain detection equipment that generally does not, or cannot, detect the third component 206.

For example, according to certain embodiments, the cover 200 can be constructed from a first component 202 that is a polymer or plastic material, and at least one of, if not both, a second component 204 comprising a metal and a third component comprising 206 a compound. The metal of the second component 204 can be ferrous, non-ferrous, and/or a combination of both. Further, according to certain embodiments, the metal of the second component 204 can take the form of flakes that can be disposed in a carrier, such as, for example, a plastic or polymer carrier. According to such an embodiment, the inclusion of metal in the construction of the cover 200 can facilitate the detection of the cover 200, or fragments of the cover 200, by metal detecting equipment.

According to embodiments in which the second component 204 is a material that is detectable by a metal detector, examples of materials for the third component 206 can include materials that are not only generally non-detectable by a metal detector, but which are also different than the first component 202. Moreover, in the present example, the compound of the third component 206 can generally not be detectable by certain types of detectors, such as, for example, a metal detector, but is detectable by another type of detector, such as, for example, an X-ray equipment, and be a material different than the polymer or plastic material of the first component 202. Examples of material for the compound of the third component 206 can include, but are not limited to, barium, such as, for example, barium sulfate, or iodine. Thus, the inclusion of such a metal as a second component 204 and a compound as a third component 206 can facilitate detection of the cover 200, or fragments of the cover 200, through either the detection of at least the second component 204 by a first detection device, such as, for example, a metal detection device, and/or by detection of the third component 206 via the use of a second, different type detection device, such as, for example, X-ray equipment. 8. Further, according to certain embodiments, the cover 110 can be detected by sonar, optical or visual detection devices.

Referencing FIGS. 2B and 3, according certain embodiments, a fixed member 208, 302 of the cover 200′, 300 can be formed from the first component 202, such as, for example, a plastic material, and can include one or both of the second and third components 204, 206, such as, for example, metal fragments and compounds. Further, according to certain embodiments, another portion or component of the cover 200′, 300, such as, for example, a rotating member 210, 304 of the cover 200′, 300, can also be formed by the first component 202, such as a polymer or plastic material, and include one or both of the second and third components 204, 206, such as, for example, metal fragments and/or compounds. According to certain embodiments, the fixed member 208, 302 and the rotating member 210, 304 can be constructed from the first component 202, such as, for example, a polymer or plastic material, and one of the fixed member 208, 302 or the rotating member 210, 304 includes the second component 204, such metal flakes, while the other of the fixed member 208, 302 and the rotating member 210, 304 includes the third component 206, namely the compound. Alternatively, according to certain embodiments, the fixed member 208, 302 can be constructed from at least one of the first, second, and/or third components 202, 204, 206 while the rotating member 210, 304 is constructed from at least one of the first, second, and third components 202, 204, 206 that is not utilized in the construction of the fixed member 208, 302.

According to certain embodiments, the second and/or third components 204, 206 can be blended with the first component 202 such that the second and/or third components 204, 206 are generally homogenously distributed throughout the associated formed cover 200, 200′. For example, according to the certain embodiments, metal particles and/or compounds of the second and/or third components 204, 206, respectively, can be blended with the plastic material of the first component 202 such that the second and/or third components 204, 206 are homogenously distributed throughout the cover 200, 200′. According to one aspect of the present teachings, the metal particles of the second component 204 can make up at least 0.1% by weight of the material forming the cover 200, 200′, and as much as 50% by weight of the material of the cover 200, 200′. Further, one or more of the third component 206, and moreover one or more compounds, can make up at least 0.1% by weight of the material forming the cover 200, 200′, and as much as 50% by weight of the material of the cover 200, 200′.

In another aspect of the present teachings, the second component 204, such as, for example, metal particles, can make up from about 1% to about 25% by weight of the material of the cover 200, 200′. Further, one or more of the third component 206, and moreover, one or more of the compounds, can make up from 0.5% to about 15% by weight of the material of the cover 200, 200′. In still another aspect of the present teachings, the second component 204, such as metal particles, can make up from about 2% to about 15% by weight of the material and one or more third components 206, such as one or more compounds, can make up from 1% to about 10% by weight of the material.

According to another aspect of the present teachings, the combination of metal particles of the second component 204 and the compound of the third component 206 can comprise from about 0.2% to 65% of the weight of the cover 200, 200′. According to another aspect of the present teachings, the metal particles and compound of the second and third components 204, 206, respectively, can comprise from about 1% to 50% of the weight of the cover 200, 200′. According to still another aspect of the present teachings, the metal particles and compound of the second and third components 204, 206 can comprise from about 5% to 25% of the weight of the cover 200, 200′. According to yet another aspect of the present teachings, the metal particles and compound of the second and third components 204, 206 can comprise from about 10% to 20% of the weight of the cover 200, 200′. The ratio of the weight of the metal particles and compound of the second and third components 204, 206 to the plastic of the first component 202 can also take any value within or without these foregoing ranges so long as sufficient detectability characteristics are met. Further, the metal and compound of the second and third components 204, 206 can be homogeneously distributed throughout the cover 200, 200′. In the event a dislodged cover 200, 200′, or even a relatively small broken fragment of the cover 200, 200′, becomes present or lodged in another product, such a construction facilitates detection of the cover 200, 200′ or fragment of the cover 200, 200′ via use of a relatively wide variety of detection devices, including, for example, a X-ray machine and/or a metal detector.

According to certain embodiments, one or more of the metal particles of the second component 204 and the compound of the third component 206 can be combined with one or more plastic resins of the first component 202 to form the material that will form the cover 200, 200′ according to the present teachings. The combined materials of the first, second, and third components 202, 204, 206 can be heated to a temperature high enough to allow the cover 200, 200′ to be formed, such as, for example, via an extrusion, injection, or molding processes. The temperature can correspond to the melting temperature of the plastic resin or the blend of plastic resins that make up the material. Plastic resins that can be used in forming the cover 200, 200′ can include, but is not limited to, polypropylene, polycarbonate, polyethylene terephthalate (PET), polyethylene including high density polyethylene (HDPE), fluoropolymers and polyamide, nylon, including nylon 6,6, nylon 6,12 or nylon 11, among other resins.

The metal particles incorporated as the second component 204 into the cover 200, 200′ can be ferrous, or non-ferrous, the latter of which could include such materials as stainless steel, aluminum, and/or copper, among other materials. Accordingly, the type of detector utilized to detect the presence of the second component 204, if any, that comprises metal can be, at least in part, based on the type of metal used for the second component 204. Conversely, the type of metal used for the second component 204 can be based on the type of detector utilized to detect the present of the second component 204, if any, in the cover 200, 200′. For example, where magnetism is the method used to detect the foreign material in the form of at least fragments of a cover 200, 200′, if not the entire dislodged cover 200, 200′ in another material or item, the second component 204 may be one or more ferrous metals. The selection of the metal or other material for use as the second component 204 can be based on a variety of different criteria, including, for example, resistance of metal particles of the second component 204 to rusting or corrosion due to the environment in which the cover 200, 200′ is used. For example, in some applications, the cover 200, 200′ may be subjected to relatively extreme wash-down areas such that corrosion resistance or other deterioration properties or characteristics of the selected metal(s) for the second component 204 may have greater consideration than in other types applications that may also employ the use of a cover 200, 200′.

According to one aspect of the present teachings, the metal particles of the second component 204 can be up to about 50% by weight of the cover 200, 200′, and in other aspects, in at least an attempt to minimize cracking of the cover 200, 200′, can be less than about 15% by weight. According to still other aspects, metal flakes of the second component 204 in amounts greater that 25% of the weight of the cover 200, 200′ can be added to the plastic resin of the first component 202 so that the cover 200, 200′ can be relatively easily detected. According to certain embodiments, the cover 200, 200′ can contain at least 0.3% by weight metal particles in order to be relatively easily detectable, and preferably at least 2% by weight and most preferably at least 5% by weight. Thus, a cover 200, 200′ containing metal particles of the second component 204 that are dispersed in the material of the first component 202 in a range of 0.1% to 50% or greater by weight can be implemented. Other sub-ranges within these ranges are also suitable, as are higher amounts in order to aid detection. According to yet another aspect of the present disclosure coated and/or encapsulated metal particles of the second component 204 having an average particle size of about 10-1000 microns, some of which are disclosed in U.S. Pat. No. 5,395,695 to Shain et al., U.S. Pat. Nos. 5,472,661 and 5,629,092 to Gay, and U.S. Pat. No. 5,679,402 to Lee, all of which are incorporated herein in their entirety.

The compounds of the third component 206 referred to herein can be contrast agents that relatively strongly absorb X-ray radiation and, therefore, can be relatively easily detected through X-ray detection equipment. According to one aspect of the present teachings, the contrasting compounds of the third component 206 can be up to about 50% by weight of the cover 200, 200′, and according to other aspects less than about 10% by weight. The contrasting compounds of the third component 206 of the present teachings are used as a marker in the material forming the cover 200, 200′ that permits the cover 200, 200′ to be relatively easily detected and located in a product or process stream. Every metal absorbs X-rays to some extent depending on the atomic number and the density within the cover 200, 200′. The contrasting compounds of the third component 206 can be selected for their ability to be relatively easily detected by X-ray detection devices when present in relatively small amounts. Thus, the ability to detect the cover 200, 200′, or fragments thereof, containing the contrasting compounds of the third component 206 using X-ray equipment can be relatively significantly enhanced. Example contrasting compounds for use as the third component 206 include, but are not limited to, iodine and barium compounds, which are relatively easy to detect using X-ray equipment. For example, one such compound that can be used as the third component 206 is barium sulfate, which typically is provided in the form of an insoluble white powder. The more barium sulfate in the material used to form the 200, 200′, the more readily the cover 200, 200′, or fragments thereof, can be detected, for example, by X-ray equipment.

According to certain embodiments, the compound of the third component 206, and the metal particles of the second component 204, can be combined with the plastic resin, and/or resins of the first component 202 prior to molding the cover 200, 200′ in at least an attempt to ensure relatively even distribution of the components 202, 204, 206 in the material that forms the cover 200, 200′. The amount of metal particles and compound of the second and third components 204, 206 added to the material forming the cover 200, 200′ can vary provided that the strength and flexibility of the cover 200, 200′ is not compromised. Accordingly, the characteristics of the cover 200, 200′ can be dependent upon the properties and processing characteristics of the specific plastic resins that are used as the first component 202, and the type and amounts of compounds and metal-based ingredients of the second and third components 204, 206.

According to one aspect of the present teachings, a method for forming the cover 200, 200′ includes combining metal particles of the second component 204, a compound of a third component, and plastic material of a first component 202 to form a composition. The composition is then heated to melt the plastic material of the first component 202. Because different plastic materials have different melting temperatures, the temperature at which the composition is heated can vary according to the plastic or plastics that are being used as the first component 202. The heated composition can then be formed into the cover 200, 200′ using a variety of different techniques, procedures, or methods for forming the cover 200, 200′. For example, according to certain embodiments, the formation of the cover 200, 200′ includes either extrusion or injection molding, among other forming techniques. After the cover 200, 200′ is formed, the cover 200, 200′ can be cooled, such as, for example, to room temperature.

The metal particles of the second component 204 can, according to certain embodiments, be metal flakes and can be encased in a plastic carrier. The plastic carrier can permit the metal flakes of the second component 204 to be more easily processed with the plastic material in conventional plastic processing equipment, such as extruders and molding machines. Any plastic that is compatible with the plastic material of the first component 202 that is used to form the cover 200, 200′ can be used as the plastic carrier. According to one aspect of the present teachings, the melting temperature of the plastic carrier is greater than the melting temperature of the plastic material of the first component. Accordingly, when the cover 200, 200′ is formed, a composition that includes at least the first component and the metal flakes of the second component that are encased in the plastic carrier, and which may or may not include the third component 206, is heated to a temperature greater than the melting temperature of the plastic material of the first component 202, but lower than or equal to the melting temperature of the plastic carrier. According to another aspect of the present teachings, the melting temperature of the plastic material of the first component 202 is lower than the melting temperature of the plastic carrier. Such an embodiment can generally assist in retaining the metal particles of the second component 204 encased in the plastic carrier and prevent the metal particles metal particles of the second component 204 from falling to the bottom of the composition during processing.

In one non-limiting example, a formulation includes 74% by weight polyamide 6,6; 13% by weight iron flakes in a plastic carrier; 5% by weight barium sulfate; and 8% concentrate colorant. The components of the formulation were mixed together and then heated to a temperature of about 600 degrees Fahrenheit (° F.). The heated mixture can then be molded into the cover 200, 200′ and subsequently cooled to room temperature.

Certain embodiments of the present application provide a shaft end closure that is formed from a composition comprising metal particles having an average particle size of between about 5 microns and about 1000 microns, a compound comprising barium, a plastic material. For example, according to certain embodiments, the metal particles can have an average particle size of between about 10 microns to 500 microns, and moreover, between about 50 microns to about 250 microns. The shaft end closure can be detected by at least one of X-ray and metal detection devices. Further, according to certain embodiments, the compound can be barium sulfate. The metal particles and the compound can comprise, for example, from about 0.2% to about 65% by weight of the composition, and moreover, about 0.5% to about 60% by weight of the composition. For example, according to certain embodiments, the metal particles can comprise from about 1% to about 25% by weight of the composition, and more specifically, can comprise from about 5% to about 20% by weight of the composition. The plastic material can comprise at least one or more of a polypropylene, a polycarbonate, a polyethylene, a polyterephthalate (PET) or a polyamide. Additionally, the shaft end closure can comprise ferrous and non-ferrous materials.

While embodiments discussed herein address a composition for use with an end cover 200, 200′, a similar composition can also be used with other components of the power transmission system. For example, according to certain embodiments, the above-discussed first component 202 and at least one of the second component 204 and third component 206 can be utilized in the construction of the housing 102, ball bearing flange, motor enclosure, gear box housing, and/or motor housing or enclosure. Further, the percentage by weight of the second component 204 and/or third component 206 in the composition, as well as the process for molding or otherwise forming such components can be similar to the above-discussed examples for the cover 200, 200′.

While select embodiments of this invention are illustrated, various modifications may occur to those skilled in the art. Therefore, it is to be understood that these modifications are incorporated within the embodiments of the present invention as if they were fully illustrated and described herein. Thus, while there have been described the preferred embodiments of the present invention, those skilled in the art will realize that other embodiments can be made without departing from the spirit of the invention, and it is intended to include all such further modifications and changes as come within the true scope of the claims set forth herein. For the purposes of this disclosure and unless otherwise specified, “a” or “an” means “one or more.” To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. From about A to B is intended to mean from about A to about B, where A and B are the specified values.

1. A detectable component for a power transmission system comprising:
a body portion structured for mounting to the power transmission component, the body portion formed from a composition comprising:
a first component comprising a polymer;
a second component comprising a material that enhances detection of the composition by a first electronic detection device, the second component comprising about 1% to about 25% by weight of the composition and having an average particle size of between about 10 microns and about 1000 microns; and
a third component comprising a compound that enhances detection of the composition by a second electronic detection device that detects different characteristics of the composition than the first electronic detection device, the third component comprising about 0.5% to about 15% by weight of the composition, the second and third components being different that the first component.

2. The detectable component of claim 1, wherein the second component is a material that enhances detection of the detectable component by metal detection equipment, and the third component is a material that enhances detection of the detectable component by X-ray equipment.

3. The detectable component of claim 2, wherein the second component is a plurality of metal particles having an average particle size of between about 50 microns and about 250 microns.

4. The detectable component of claim 3, wherein the plurality of metal particles comprises a ferrous material.

5. The detectable component of claim 3, wherein the plurality of metal particles comprises a non-ferrous material.

6. The detectable component of claim 2, wherein the second component is a plurality of metal particles comprise metal flakes in a plastic carrier.

7. The detectable component of claim 2, wherein the third component is one or more compounds that includes at least one of barium and barium sulfate.

8. The detectable component of claim 2, wherein the composition includes both the second component and the third component, the second component comprising a plurality of metal particles, the third component comprising one or more compounds, and wherein the second and third components comprise from about 1% to about 10% by weight of the composition.

9. The detectable component of claim 1, wherein the first component is a plastic material that comprises at least one of a polypropylene, a polycarbonate, a polyethylene, a high-density polyethylene, a polyterephthalate (PET), and a polyamide.

10. The detectable component of claim 1, wherein the second component and the third component generally homogenously distributed throughout the composition.

11. A detectable component for a power transmission system formed from a composition comprising:
a first component comprising at least one of a polypropylene, a polycarbonate, a polyterephthalate (PET) and a polyamide;
a second component comprising a plurality of metal particles in a plastic carrier, the metal particles comprising at least 0.3% by weight of the composition and having an average particle size of at least 10 microns; and
a third component comprising barium sulfate, the third component comprising at least 0.5% by weight of the composition, the composition of the detectable component being detectable by X-ray and metal detection devices, the second and third components being homogenously distributed throughout the composition.

12. The detectable component of claim 11, wherein the plurality of metal particles and the barium sulfate comprise from about 1% to about 20% by weight of the composition.

13. The detectable component of claim 11, wherein the plurality of metal particles comprises a ferrous material.

14. The detectable component of claim 11, wherein the plurality of metal particles comprises metal flakes.

15. The detectable component of claim 11, wherein the plurality of metal particles comprises ferrous flakes, and wherein the first component is a polyamide, the polyamide being a nylon.

16. The detectable component of claim 11, wherein the plurality of metal particles comprise at least 0.3% by weight of the composition and the barium sulfate comprises at least 0.5% by weight of the composition.

17. The detectable component of claim 11, wherein the metal particles of the plurality of metal particles have a weight average particle size of between about 20 microns and about 500 microns.

18. The detectable component of claim 11, wherein the plastic material is polypropylene and the compound is barium sulfate.

19. The detectable component of claim 11, wherein the metal particles of the plurality of metal particles have an average particle size of up to about 500 microns.

20. The detectable component of claim 19, wherein the second component comprises about 1% to about 25% by weight of the composition and the third component comprises about out 0.5% to about 15% by weight of the composition.

21. The detectable component of claim 1, wherein the detectable component is at least one of a shaft end closure and a housing.

22. The detectable component of claim 11, wherein the detectable component is at least one of a shaft end closure and a housing.
